(19) United States
(12) Patent Application Publication
(10) Pub. No.: US 2024/0263666 A1
(43) Pub. Date: Aug. 8, 2024

(54) FASTENING MEMBER

(71) Applicant: AOYAMA SEISAKUSHO CO., LTD., Niwa-Gun (JP)

(72) Inventor: Naoki HOSHINO, Niwa-Gun (JP)

(73) Assignee: AOYAMA SEISAKHUSHO CO., LTD., Niwa-Gun (JP)

(21) Appl. No.: 18/411,148

(22) Filed: Jan. 12, 2024

(30) Foreign Application Priority Data
Feb. 6, 2023 (JP) 2023-016035
Feb. 6, 2023 (JP) 2023-016036

(51) Int. Cl. F16B 39/282

(52) U.S. Cl. CPC F16B 39/282

(57) ABSTRACT

The present invention provides a fastening member capable of suppressing generation of a burr and deformation around a mating member at a time of caulking without reducing a caulking strength such as an idling torque and a pull-off load. The fastening member includes a bearing surface (11) press-fitted into a mating member at the time of caulking, a fastening function portion (40) formed at a central portion of the bearing surface, and a plurality of protrusions (20) formed to protrude from the bearing surface at positions surrounding the fastening function portion. These protrusions (20) include an inclined surface (22) inclined so as to approach the bearing surface from an outer peripheral side toward an inner peripheral side, and pull the mating member toward a center side at the time of caulking to prevent deformation of a periphery.

### TECHNICAL FIELD

The present invention relates to a fastening member such as a caulking bolt or a caulking nut that is caulked and fixed to a mating member such as a metal plate.

### BACKGROUND ART

In order to attach another member to a mating member, it is common that bolt insertion holes are formed in both members, bolts are inserted, and nuts are screwed and fixed to external thread portions of the bolts. However, in a technical field represented by an automobile, in order to simplify a structure and reduce an assembling process, a welding bolt for welding and fixing a head portion of a bolt to a metallic mating member, and a caulking bolt for passing a shaft portion through a pilot hole formed in the metallic mating member and press-fitting and fixing the head portion of the bolt to the mating member are used. Similarly, a welding nut to be welded to the mating member and a caulking nut to be caulked and fixed to the mating member are also used. The fastening members herein include both bolts and nuts.

These fastening members are used to attach other members after being caulked and fixed to the mating member. For example, a bolt receives a rotational torque when the bolt and another member are fastened with a nut. At this time, when the bolt rotates with respect to the mating member, it is difficult to perform fastening work. Therefore, the caulked and fixed fastening member is required to have a large idling torque (torque to start idling). In addition, it is required that a pull-off load be large so that the fastening member is not peeled off from the mating member to which the fastening member is caulked and fixed when the fastening member is subjected to a tensile load. The same applies to a case where the fastening member is a nut.

Therefore, the present inventor has previously developed the caulking bolt of Patent Literature 1 in which a star-shaped protrusion is formed on a bearing surface. This caulking bolt can obtain a large idling torque by press-fitting the star-shaped protrusion formed on the bearing surface into a surface of the mating member at a time of caulking. In addition, by allowing a metal material of the mating member to flow into an incomplete thread portion formed between the shaft portion and the bearing surface, a caulking strength is increased, and a large pull-off load can be obtained.

However, depending on a plate thickness and a strength of the mating member, the mating member may deform and flow in a press-fitting direction at the time of caulking, and a burr may be generated at an end edge of the pilot hole of the mating member. In the case of the caulking bolt, since the burr is generated at an upper end of the thread portion of the bolt, it becomes a problem if the burr large. In addition, the mating member may be pushed out in a radial direction at the time of caulking, and deformation may occur in the surrounding mating member. This problem is particularly noticeable when the mating member is a soft metal such as copper or aluminum. For this reason, the inventor of the present invention has repeatedly conducted studies in order to develop a fastening member that solves these problems without reducing the caulking strength such as the idling torque and the pull-off load.

Since there are many prior Patent Literatures on a caulk-type fastening member, the caulk-type fastening member will be briefly described below. Patent Literature 2 describes a caulking bolt in which a star-shaped protrusion similar to that in Patent Literature 1 is formed on the bearing surface. However, since the shape of the bearing surface is similar to that of the caulking bolt of Patent Literature 1, there is a problem similar to that of the caulking bolt of Patent Literature 1 described above.

Patent Literatures 3 and 4 disclose a caulking bolt and a caulking nut having a large number of radial protrusions on the bearing surface. However, these radial protrusions are connected to a pedestal portion formed on the shaft portion. For this reason, the metal material of the mating member is pushed out in the press-fitting direction and the radial direction in a larger amount than the caulking bolt of Patent Literature 1 at the time of caulking, which may cause a burr or deform the periphery.

Patent Literature 5 also discloses a caulking bolt and a caulking nut having a large number of radial protrusions on the bearing surface. These radial protrusions are located away from the shaft portion. However, there is a possibility that the metal material of the mating member is pushed out in the radial direction at the time of caulking to deform the periphery, which is similar to the cases of the fastening members of the respective Patent Literatures described above.

### CITATION LIST

### Patent Literature

Patent Literature 1: JP 6214696 B

Patent Literature 2: U.S. Pat. No. 5,513,933

Patent Literature 3: JP 5981008 B

Patent Literature 4: JP 5567898 B

Patent Literature 5: U.S. Pat. No. 5,797,175

### SUMMARY OF INVENTION

### Technical Problem

An object of the present invention is to solve the above-described conventional problems, and to provide a fastening member capable of suppressing generation of a burr and deformation of a periphery of a mating member at a time of caulking without reducing a caulking strength such as an idling torque and a pull-off load.

### Solution to Problem

A fastening member of the present invention made to solve the above problems is a fastening member that is caulked and fixed to a mating member, the fastening member characterized by including: a bearing surface that is press-fitted into the mating member or comes into contact with the mating member at a time of caulking; a fastening function portion formed in a central portion of the bearing surface; and a plurality of protrusions formed to protrude from the bearing surface at positions surrounding the fastening function portion, characterized in that the protrusions include inclined surfaces inclined to approach the bearing surface from an outer peripheral side toward an inner peripheral side.

A fastening member according to a preferred embodiment includes a recess between the fastening function portion and the bearing surface, into which a material of the mating member flows in at the time of caulking. In a fastening member of another preferred embodiment, the plurality of protrusions includes a ring-shaped protrusion and a radial protrusion formed at a position between the fastening function portion and the ring-shaped protrusion.

The fastening function portion may be a shaft portion including an external thread. The fastening function portion may be a through hole having an internal thread or having no internal thread. When the fastening function portion is the shaft portion including the external thread, a recess into which the material of the mating member flows at the time of caulking can be formed between the bearing surface and an incomplete thread portion of an end portion of the external thread. In addition, a recess into which the material of the mating member flows at the time of caulking can be formed between the bearing surface and a ring formed at an end portion of the shaft portion including the external thread. In a case where the fastening function portion is the through hole, a recess into which the material of the mating member flows at the time of caulking can be formed between the bearing surface and an annular leg portion formed around the through hole.

### Advantageous Effects of Invention

In the fastening member of the present invention, the plurality of protrusions formed to protrude from the bearing surface are press-fitted into the mating member at positions surrounding the fastening function portion formed in the central portion of the bearing surface and are caulked and fixed to the mating member, so that a large idling torque can be obtained. Since these protrusions include inclined surfaces inclined so as to approach the bearing surface from the outer peripheral side toward the inner peripheral side, when the bearing surface is press-fitted into the mating member, these inclined surfaces exert an action of attracting the mating member toward a center side of the bearing surface. Therefore, an action of pushing the mating member radially outward at the time of caulking is suppressed, and deformation of the surrounding mating member can be suppressed. Furthermore, if the recess into which the material of the mating member flows at the time of caulking is provided between the fastening function portion and the bearing surface, the mating member is prevented from deforming and flowing in a press-fitting direction at the time of caulking, and generation of a burr can be prevented.

### BRIEF DESCRIPTION OF DRAWINGS

FIG. 1 is a perspective view illustrating an entire fastening member (caulking bolt) of a first embodiment.

FIG. 2 is a cross-sectional view of the fastening member of the first embodiment.

FIG. 3 is a perspective view of a main part of the fastening member of the first embodiment.

FIG. 4 is a cross-sectional view of the main part of the fastening member of the first embodiment.

FIGS. 5(A)-(B) are explanatory views of an angle of a protrusion.

FIGS. 6(A)-(D) are views illustrating a CAE analysis result of the caulking bolt of Patent Literature 1.

FIGS. 7(A)-(D) are diagrams illustrating a CAE analysis result of the caulking bolt of the first embodiment.

FIG. 8 is a perspective view of a main part of a fastening member (caulking bolt) of a second embodiment.

FIG. 9 is a perspective view of a main part of a fastening member (caulking bolt) of a third embodiment.

FIG. 10 is a cross-sectional view of the main part of the fastening member (caulking bolt) of the third embodiment.

FIG. 11 is a perspective view illustrating an entire fastening member (caulking nut) of a fourth embodiment.

FIG. 12 is a cross-sectional view of the fastening member of the fourth embodiment.

FIG. 13 is a perspective view illustrating an entire fastening member (caulking bolt) of a fifth embodiment.

FIG. 14 is a cross-sectional view of a shaft portion of the fastening member of the fifth embodiment.

FIG. 15 is a cross-sectional view taken along line A-A and a cross-sectional view taken along line B-B in FIG. 14.

FIGS. 16(A)-(B) are explanatory views of an angle of a radial protrusion.

FIGS. 17(A)-(D) are views illustrating a CAE analysis result of the caulking bolt of the fastening member of the fifth embodiment.

FIG. 18 is a perspective view illustrating an entire fastening member (caulking nut) of a sixth embodiment.

FIG. 19 is a cross-sectional view of the fastening member of the sixth embodiment.

### DESCRIPTION OF EMBODIMENTS

### First Embodiment

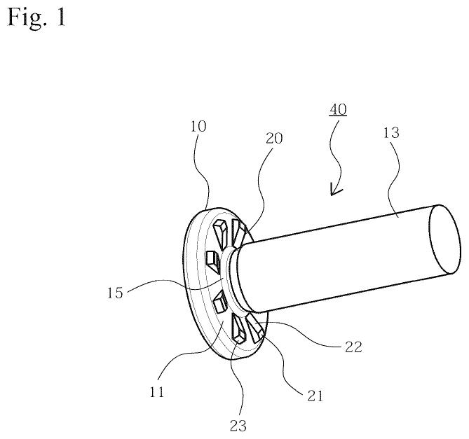

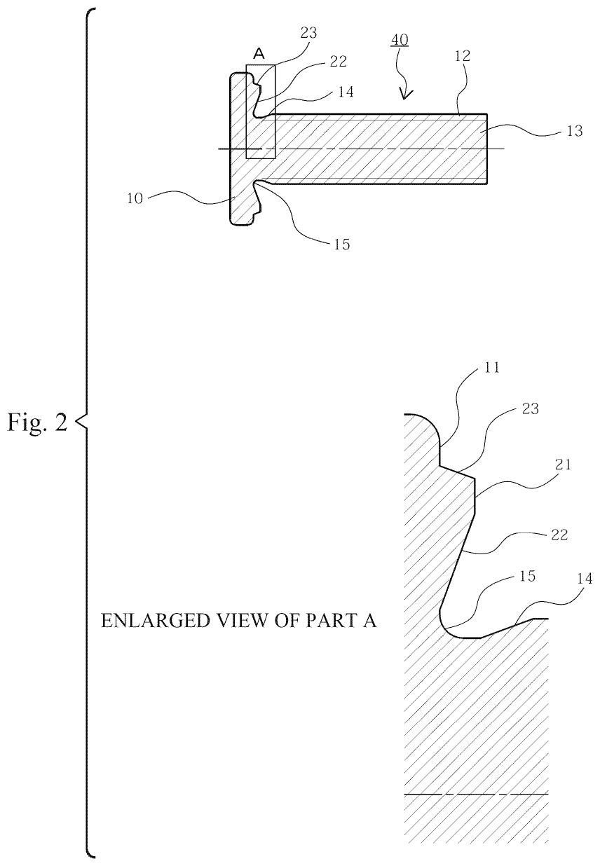

A fastening member of a first embodiment is a caulking bolt illustrated in FIGS. 1 and 2. The fastening member includes a head portion 10 and a bearing surface 11 formed on a back surface of the head portion and press-fitted to a surface of a metallic mating member at a time of caulking. In this embodiment, the bearing surface 11 has a circular shape when viewed from a direction perpendicular to the bearing surface, but may have a polygonal shape such as a quadrangle or a hexagon, or other shapes.

A fastening function portion 40 is formed in a central portion of the bearing surface 11. The fastening function portion 40 is a portion that includes a thread and exhibits a fastening function. When the fastening member is the caulking bolt as in this embodiment, the fastening function portion 40 is a shaft portion 13 of a shaft caulking bolt including an external thread 12. An end portion of the external thread 12 on the head portion 10 side is an incomplete thread portion 14. The incomplete thread portion 14 is a portion where a thread height inevitably formed at an end portion thereof gradually decreases when the external thread 12 is made by being rolled using a rolling die.

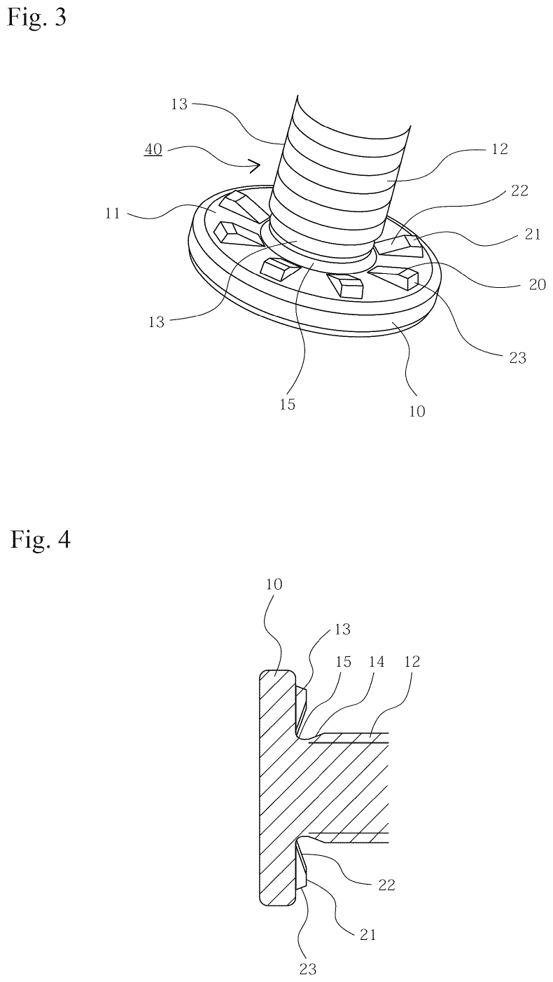

As illustrated in FIG. 3, a plurality of protrusions 20 are formed on the bearing surface 11 to protrude from the bearing surface 11 at positions surrounding the shaft portion 13, which is the fastening function portion 40. In this embodiment, the protrusion 20 has a constant width in a circumferential direction, and a total of eight protrusions are formed radially around the fastening function portion 40. However, the number of the protrusions 20 may be appropriately increased or decreased within a range of about four to twelve.

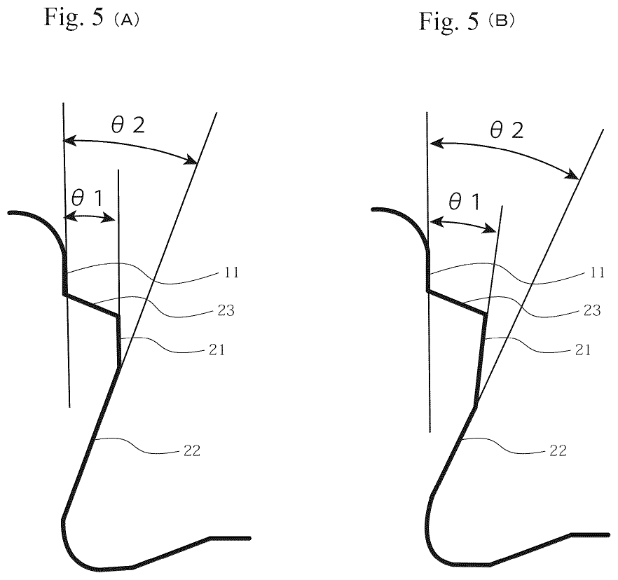

As illustrated in FIGS. 2 and 3, the protrusion 20 has a flat surface 21 on its outer peripheral side and an inclined surface 22 on its inner peripheral side. The inclined surface 22 is inclined so as to approach the bearing surface 11 from the outer peripheral side toward the inner peripheral side. As illustrated in FIG. 5(A), in this embodiment, since the flat surface 21 is parallel to the bearing surface 11, an angle θ1 of the flat surface 21 with respect to the bearing surface 11 is 0°, and an angle θ2 of the inclined surface 22 with respect to the bearing surface 11 is 20°. However, as illustrated in FIG. 5(B), the flat surface 21 located on the outer peripheral side of the inclined surface 22 may be inclined in the same direction as the inclined surface 22, that is, so as to gradually approach the bearing surface 11 toward the inner peripheral side, and θ1 can be set to 0° to 10°. The angle θ2 of the inclined surface 22 with respect to the bearing surface 11 can also be changed in the range of 10° to 70°. In the present embodiment, an inner peripheral end of the inclined surface 22 is flush with the bearing surface 11. The outer peripheral side of the flat surface 21 of the protrusion 20 is a steep slope 23. The angle between the steep slope 23 and the bearing surface 11 is preferably 60° to 90°.

As illustrated in FIG. 4, the inner peripheral end of each protrusion 20 is close to the shaft portion 13, which is the fastening function portion 40, and a recess 15 into which a material of the mating member pushed out by each protrusion 20 at the time of caulking flows is formed between the bearing surface 11 and the incomplete thread portion 14 at the end portion of the external thread 12. In the present embodiment, the inner peripheral ends of the respective protrusions 20 are separated from each other, and there is no pedestal that connects the inner peripheral ends as in a conventional case.

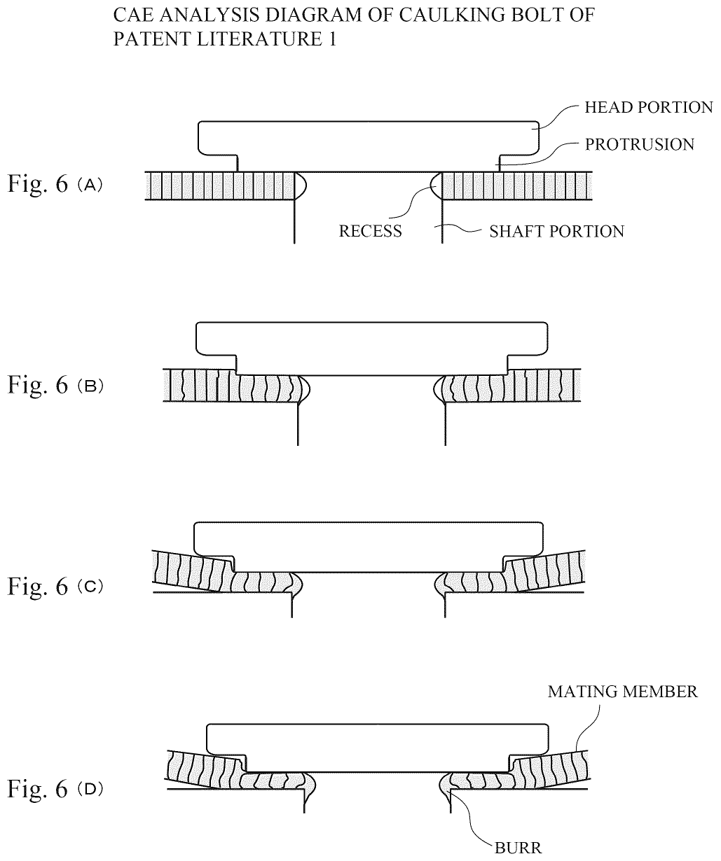

Next, the result of performing CAE analysis on the caulking bolt having a star-shaped protrusion on the bearing surface described in Patent Literature 1 and the caulking bolt of the first embodiment of the present invention will be described. FIGS. 6(A)-(D) are CAE analysis diagrams of the caulking bolt of Patent Literature 1, and when the head portion of the caulking bolt is press-fitted into the mating member from an initial state in FIG. 6(A), a small burr is generated between an inner peripheral lower portion of a pilot hole and the shaft portion of the caulking bolt at an initial stage of press-fitting as illustrated in FIG. 6(B). Then, as illustrated in FIG. 6(C), when a lower portion of a neck portion is filled with the material of the mating member, the material that has lost a place to go spreads in an outer peripheral direction, and the metal plate, which is the mating member, starts to warp. In addition, a portion that cannot escape to an outer periphery in the process of filling the lower portion of the neck portion with the material of the mating member is pushed downward as a burr, and finally causes a large burr and deformation of the periphery as illustrated in FIG. 6(D).

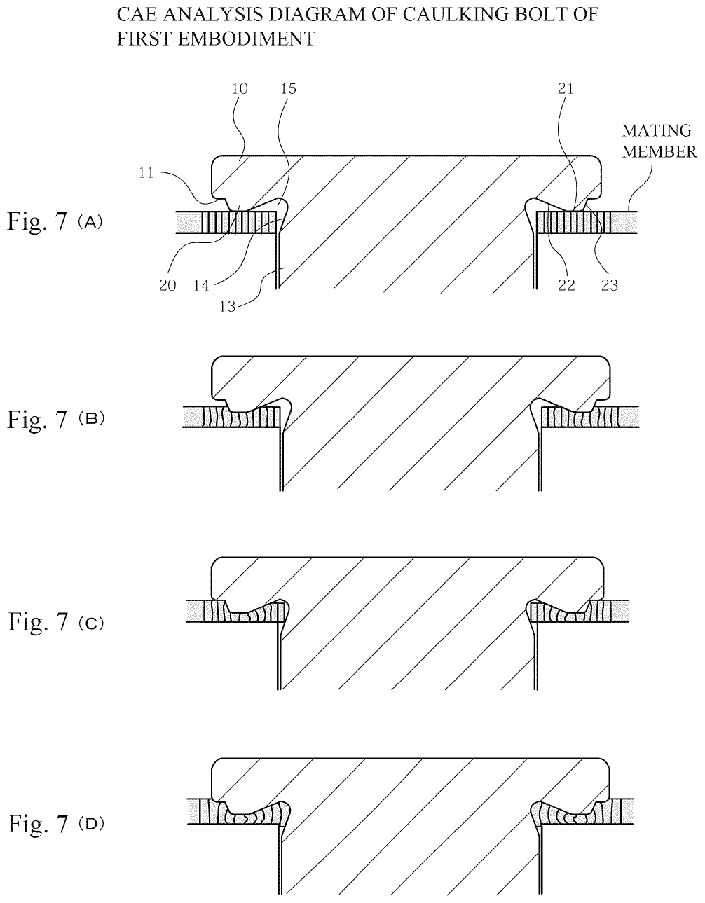

On the other hand, in the caulking bolt according to an embodiment of the present invention, as illustrated in FIGS. 7(A)-(D), when the protrusion 20 of the bearing surface 11 is press-fitted into the mating member, the inclined surface 22 formed on the inner peripheral side of the protrusion 20 attracts the material of the mating member inward, so that the material does not spread in the outer peripheral direction as illustrated in FIGS. 6(A)-(D), and the periphery is not deformed. It has been confirmed that the steep slope 23 bites the mating member at a steep angle in the caulking process to inhibit movement of the mating member in an inner direction, and generation of a burr is suppressed because a space is formed between the bearing surface 11 and the mating member at the start of caulking. When the caulking is completed, the material of the mating member flows into the recess 15 and is caulked and fixed. As described above, according to the present invention, deformation of the surrounding mating member can be suppressed. Furthermore, generation of a burr can be prevented.

### Second Embodiment

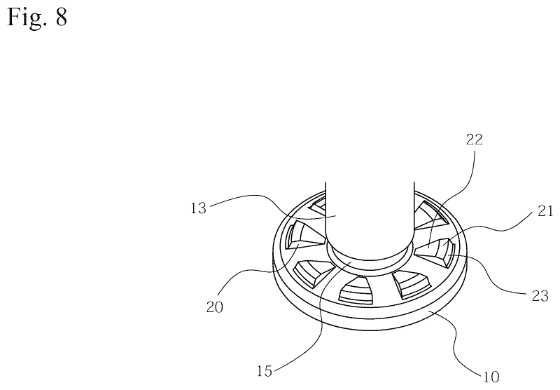

FIG. 8 illustrates a caulking bolt of a second embodiment. In the first embodiment described above, each protrusion 20 has a constant width in the circumferential direction and is rectangular when viewed from an axial direction, but in the second embodiment, the width of each protrusion 20 is wide on the outer peripheral side and narrow on the inner peripheral side, and is fan-shaped when viewed from the axial direction. Further, an interval between the protrusions 20 is constant. However, similarly to the first embodiment, the flat surface 21, the inclined surface 22, and the steep slope 23 inclined so as to gradually approach the bearing surface 11 from the outer peripheral side toward the inner peripheral side are provided.

Also in the caulking bolt of the second embodiment, when the bearing surface 11 is press-fitted into the mating member, the inclined surface 22 formed on the inner peripheral side of the protrusion 20 attracts the material of the mating member inward, so that it is possible to obtain the same operation and effect as those of the first embodiment.

### Third Embodiment

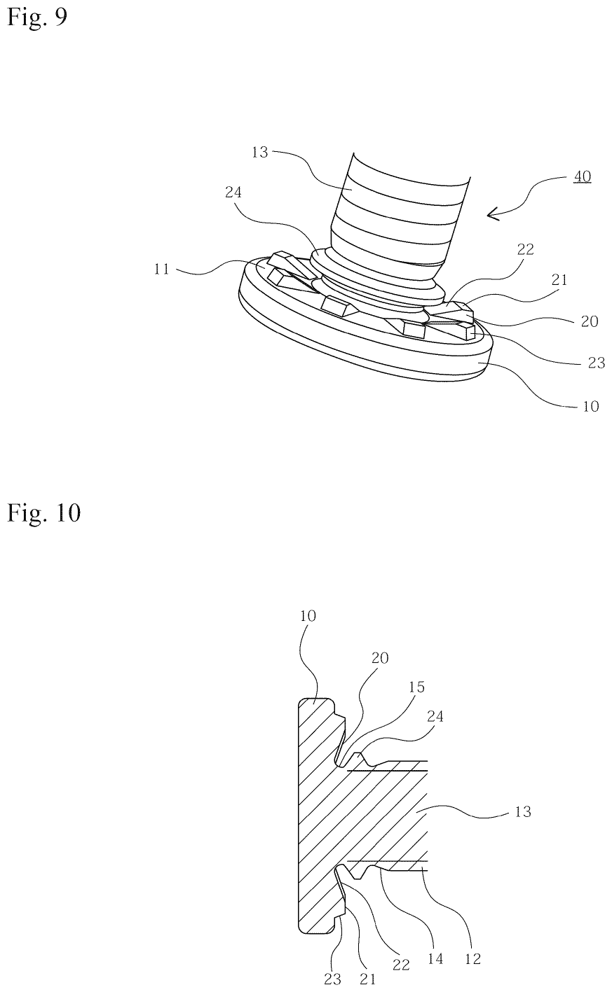

FIGS. 9 and 10 illustrate a caulking bolt of a third embodiment. In the caulking bolt, a ring 24 is provided at a position close to the bearing surface 11 of the shaft portion 13, which is the fastening function portion 40, and the recess 15 is formed between the ring 24 and the bearing surface 11. The diameter of the ring 24 is larger than the outer diameter of a thread of the external thread 12, and the incomplete thread portion 14 is formed adjacent to the ring 24. Other structures are the same as those of the first embodiment.

The caulking bolt having this structure has an advantage in that the shape and size of the recess 15 into which the material of the mating member pushed out by each protrusion 20 flows at the time of caulking can be more freely designed than in the first embodiment. However, in a case where the distance between the bearing surface 11 and the external thread 12 is longer than that in the first embodiment and the plate thickness of the mating member and the target fastening member is small, the ring 24 may 24 may become an obstacle and the nut may not be sufficiently tightened. Therefore, which one of the first embodiment and the third embodiment is selected should be considered depending on the place of use.

### Fourth Embodiment

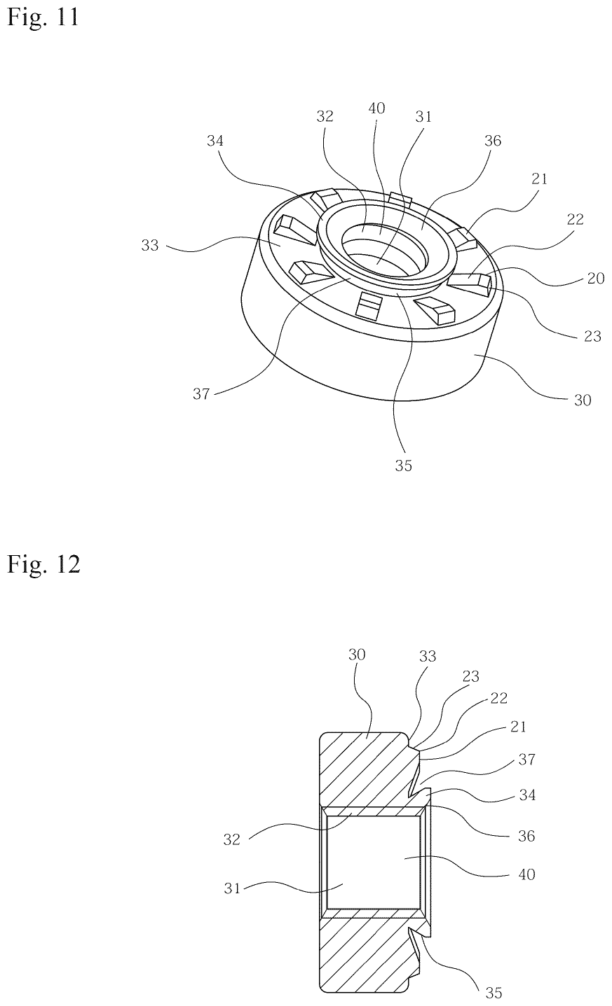

A fastening member of a fourth embodiment illustrated in FIGS. 11 and 12 is a caulking nut. This fastening member includes a nut main body 30 and a bearing surface 33 formed on a back surface of the nut main body 30 and press-fitted into a metallic mating member at the time of caulking. In the present embodiment, the bearing surface 33 has a circular shape, but may have a polygonal shape such as a quadrangle or a hexagon, or other shapes. In the present embodiment, the nut main body 30 has a circular shape when viewed from the direction perpendicular to the bearing surface 33, but may have a polygonal shape such as a quadrangle or a hexagon, or other shapes.

The fastening function portion 40 is formed in the central portion of the bearing surface 33. The fastening function portion 40 is a portion that includes a thread and exhibits a fastening function. When the fastening member is a caulking nut, the fastening function portion 40 is usually a through hole 31 in which an internal thread 32 is formed. However, the internal thread 32 may be omitted in some cases. Similarly, to the first embodiment, the plurality of protrusions 20 are provided on the bearing surface 33 of the nut main body 30 so as to surround the fastening function portion 40. The shape of the protrusion 20 of the fourth embodiment is the same as that of the first embodiment, but may be the same as that of the second embodiment.

An annular leg portion 34 is formed on the bearing surface 33 of the nut main body 30 so as to surround a periphery of the through hole 31. The annular leg portion 34 has a function of punching out the mating member when the caulking nut is caulked to the mating member, and an outer peripheral surface 35 and an inner peripheral surface 36 of the annular leg portion 34 are tapered surfaces inclined toward the outer peripheral side with respect to the bearing surface 33. A recess 37 into which the material of the mating member flows at the time of caulking is formed between the annular leg portion 34 and the bearing surface 33.

Even when the fastening member is the caulking nut, the functions of the protrusion 20 and the recess 37 are the same as those in the case with the caulking bolt, and it is possible to prevent generation of a burr and to prevent deformation of the mating member in the same manner as described above.

As described above, the fastening member of the present invention has an advantage that it is possible to suppress generation of a burr and deformation of the periphery of the mating member at the time of caulking without reducing a caulking strength such as an idling torque and a pull-off strength. Needless to say, when the fastening function portion 40 is the shaft portion 13 of the bolt, fastening is performed by the nut, and when the fastening function portion 40 is the through hole 31 of the nut, fastening is performed by the bolt.

### Fifth Embodiment

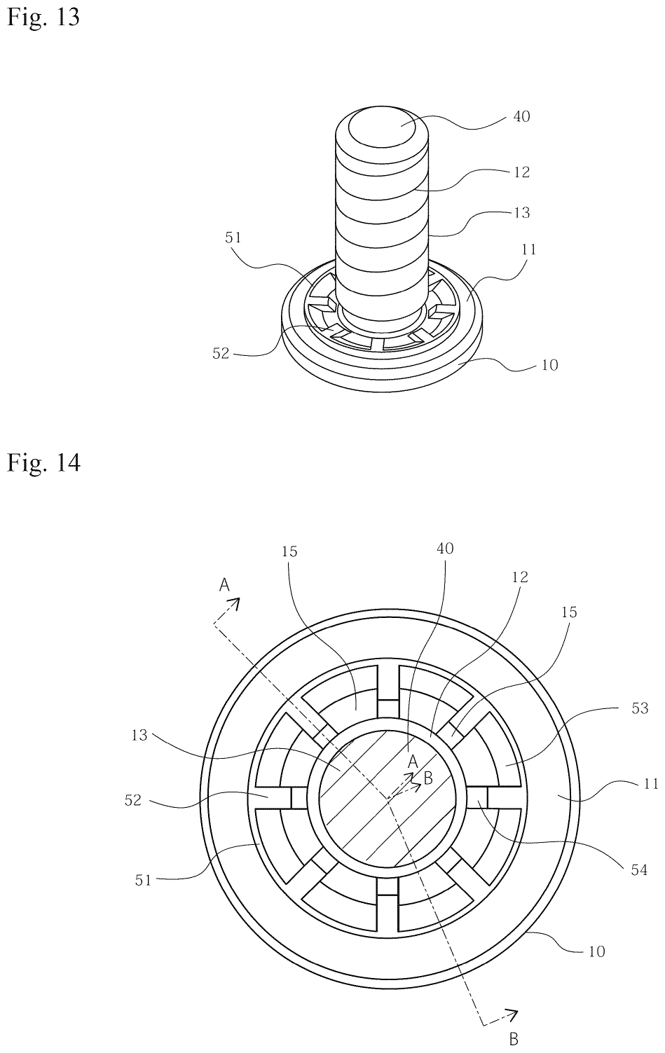

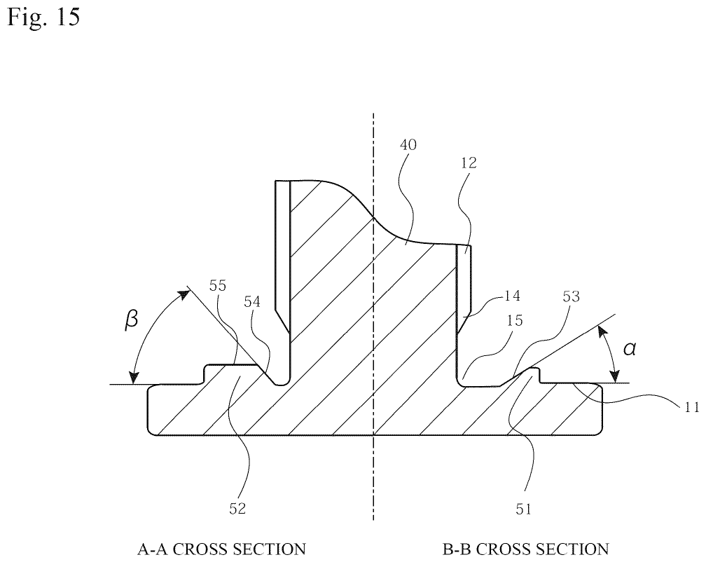

FIGS. 13 to 17(D) illustrate a fifth embodiment. As illustrated in FIGS. 13 to 15, a ring-shaped protrusion 51 and a radial protrusion 52 are formed on the bearing surface 11 of the head portion 10 at positions surrounding the shaft portion 13, which is the fastening function portion 40. The ring-shaped protrusion 51 is formed to protrude substantially perpendicularly from the bearing surface 11, and a first inclined surface 53 is formed on the inner peripheral side thereof. As illustrated in FIG. 15, an angle α formed by the first inclined surface 53 with respect to the bearing surface 11 is preferably 10° to 45°. In this embodiment, the diameter of the ring-shaped protrusion 51 is about 70% of the outer diameter of the head portion 10, but may be appropriately enlarged. However, when the diameter of the ring-shaped protrusion 51 is reduced, the ring-shaped protrusion approaches the shaft portion 13, which is the fastening function portion 40, and the action and effect of the first inclined surface 53 described later are impaired. Therefore, it is not very preferable to reduce the diameter to half or less of the outer diameter of the head portion 10. Conversely, when the diameter of the ring-shaped protrusion 51 is increased to be closer to the outer diameter of the head portion 10, caulking processing is less likely to be performed. Therefore, the diameter of the ring-shaped protrusion 51 is desirably in a range of 50% to 80% of the outer diameter of the head portion 10.

The radial protrusion 52 is formed at a position between the fastening function portion 40 and the ring-shaped protrusion 51. The radial protrusion 52 is also formed to protrude from the bearing surface 11, and in the present embodiment, the height of the radial protrusion 52 is the same as the height of the ring-shaped protrusion 51, but is not necessarily the same. The radial protrusion 52 extends toward the fastening function portion 40, and a second inclined surface 54 is formed on the inner peripheral side thereof. The second inclined surface 54 is an inclined surface steeper than the first inclined surface 53 of the ring-shaped protrusion 51, and an angle β formed by the second inclined surface 54 with respect to the bearing surface 11 is preferably 15° to 70° as illustrated in FIG. 15.

The second inclined surface 54 of the radial protrusion 52 extends to the vicinity of the fastening function portion 40. Therefore, in this portion, the recess 15 between the incomplete thread portion 14 and the bearing surface 11 of the head portion 10 is narrowed. An outer peripheral end of a flat surface 55 of the radial protrusion 52 is connected to the ring-shaped protrusion 51. The radial length of the radial protrusion 52 is about 25% of the diameter of the head portion 10 in the present embodiment. However, as the diameter of the ring-shaped protrusion 51 increases, the radial length of the radial protrusion 52 also increases.

In the present embodiment, eight radial protrusions 52 are arranged at equal intervals. However, the number is arbitrary as long as it is two or more. When the number of the radial protrusions 52 is too large, the space between the radial protrusions 52 is reduced, and the effect of the present invention is impaired. Therefore, the number of the radial protrusions is preferably twelve or less.

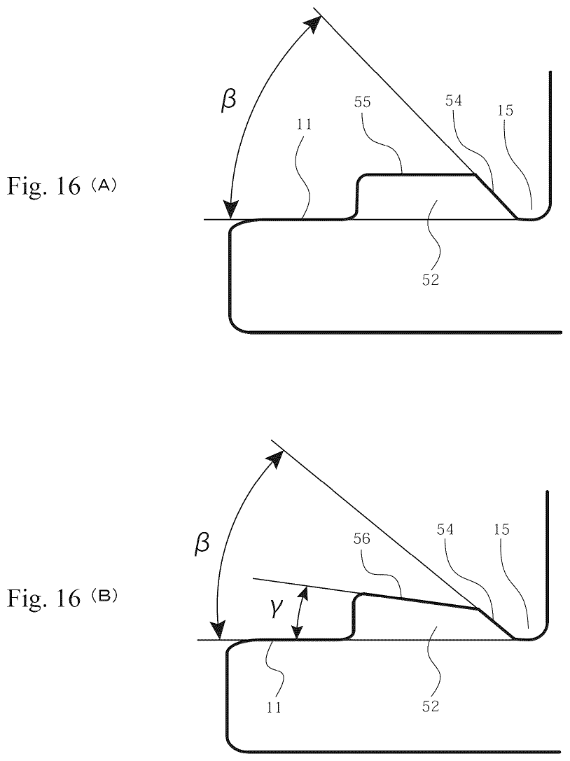

As illustrated in an enlarged manner in FIG. 16(A), in this embodiment, the flat surface 55 of the radial protrusion 52 is parallel to the bearing surface 11. However, as illustrated in FIG. 16(B), the radial protrusion 52 may have a plurality of inclined surfaces having different inclination angles with respect to the bearing surface 11, and an inclination angle γ of an inclined surface 56 on the outer peripheral side may be smaller than the inclination angle β of the second inclined surface 54, which is the inclined surface on the inner peripheral side. At this time, the angle γ between the inclined surface 56 and the bearing surface 11 can be changed in the range of 0° to 10°.

As illustrated in FIG. 15, the inner peripheral end of the second inclined surface 54 of the radial protrusion 52 is close to the shaft portion 13, which is the fastening function portion 40, and the recess 15 into which the material of the mating member pushed out by the ring-shaped protrusion 51 or the radial protrusion 52 at the time of caulking flows is formed between the bearing surface 11 and the incomplete thread portion 14 of the end portion of the external thread 12. In the present embodiment, the inner peripheral ends of the radial protrusions 52 are separated from each other, and there is no pedestal that connects the inner peripheral ends as in the conventional case.

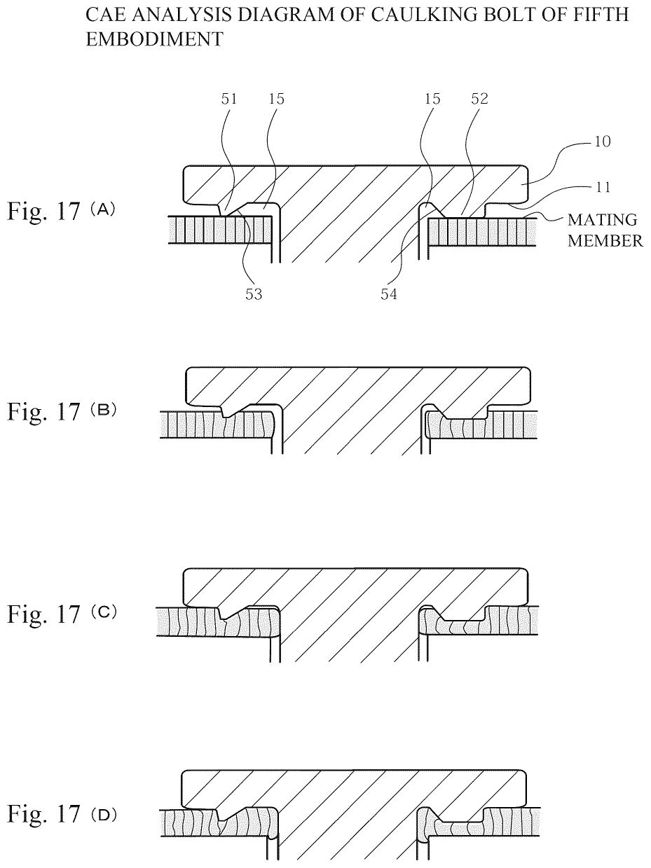

FIGS. 17(A)-(D) illustrate the result of performing CAE analysis on the caulking bolt of the fifth embodiment. See also the CAE analysis diagram of the caulking bolt of Patent Literature 1 illustrated in FIGS. 6(A)-(D). As described above, the caulking bolt of Patent Literature 1 causes a large burr and deformation of the surrounding mating member.

On the other hand, in the caulking bolt of the fifth embodiment of the present invention illustrated in FIG. 17(A), when the ring-shaped protrusion 51 and the radial protrusion 52 of the bearing surface 11 are press-fitted into the mating member, the first inclined surface 53 of the ring-shaped protrusion 51 and the second inclined surface 54 of the radial protrusion 52 attract the material of the mating member inward (see FIG. 17(B)), and thus the material does not spread in the outer peripheral direction as illustrated in FIG. 6, and the periphery is not deformed such as by warpage. It has been confirmed that the ring-shaped protrusion 51 bites the mating member at a steep angle in the caulking process (see FIG. 17(C)), hinders the movement of the mating member in the inward direction, and at the start of caulking, the recess 15 is formed between the bearing surface 11 and the mating member, so that generation of a burr is suppressed (see FIG. 17(D)). When the caulking is completed, the material of the mating member flows into the recess 15 and is caulked and fixed.

### Sixth Embodiment

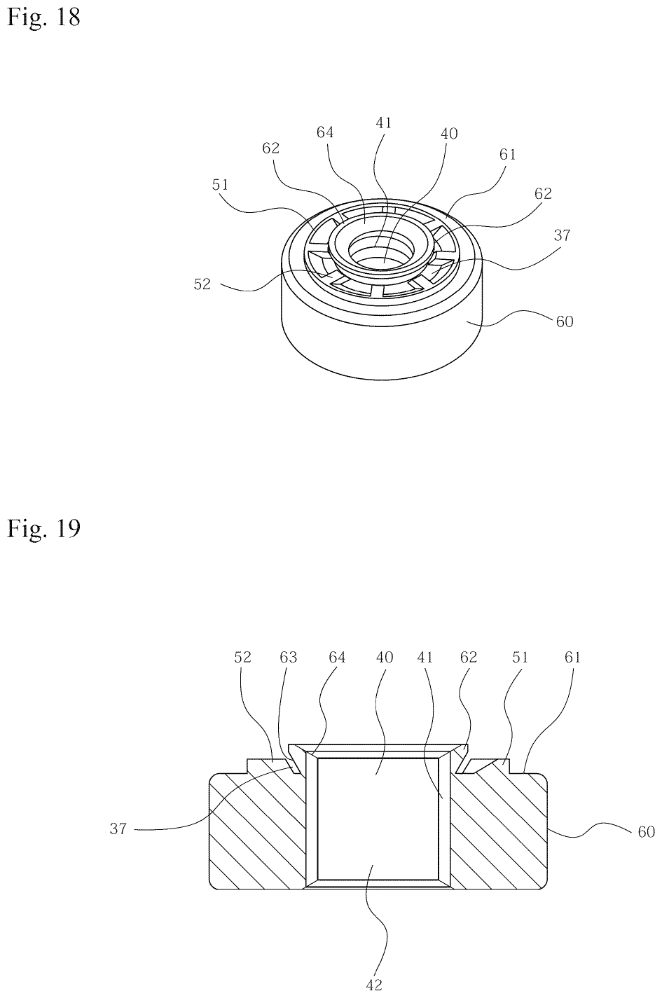

FIGS. 18 and 19 illustrate a caulking nut according to a sixth embodiment of the present invention. The fastening member includes a nut main body 60 and a bearing surface 61 formed on the back surface of the nut main body 60 and press-fitted into a metallic mating member at the time of caulking. In the present embodiment, the bearing surface 61 has a circular shape, but may have a polygonal shape such as a quadrangle or a hexagon, or other shapes.

The fastening function portion 40 is formed in the central portion of the bearing surface 61. The fastening function portion 40 is a portion that exhibits a fastening function. When the fastening member is a caulking nut, the fastening function portion 40 is usually a through hole 42 in which an internal thread 41 is formed. However, the internal thread 41 may be omitted in some cases. Similarly to the fifth embodiment, the ring-shaped protrusion 51 and the radial protrusion 52 are provided on the bearing surface 61 of the nut main body 60 so as to surround the fastening function portion 40. The shapes of the ring-shaped protrusion 51 and the radial protrusion 52 of the second embodiment are the same as those of the fifth embodiment.

An annular leg portion 62 is formed on the bearing surface 61 of the nut main body 60 so as to surround the periphery of the through hole 42. The annular leg portion 62 has a function of punching out the mating member when the caulking nut is caulked to the mating member, and an outer peripheral surface 63 and an inner peripheral surface 64 of the annular leg portion 62 are tapered surfaces inclined toward the outer peripheral side with respect to the bearing surface 61. The recess 37 into which the material of the mating member flows at the time of caulking is formed between the annular leg portion 62 and the bearing surface 61.

Even when the fastening member is the caulking nut, the functions of the ring-shaped protrusion 51 and the radial protrusion 52 are the same as those in the case with the caulking bolt, and generation of a burr can be prevented and deformation of the mating member can be prevented in the same manner as described above.

As described above, the fastening member of the present invention has an advantage that it is possible to suppress generation of a burr at the time of caulking and deformation such as warpage of the periphery of the mating member without reducing the caulking strength such as the idling torque and the pull-off strength. Needless to say, when the fastening function portion 40 is the shaft portion 13 of the bolt, the fastening is performed by the nut, and when the fastening function portion 40 is the through hole 42 of the nut, the fastening is performed by the bolt.

### REFERENCE SIGNS LIST

10 Head portion
11 Bearing surface
12 External thread
13 Shaft portion
14 Incomplete thread portion
15 Recess
20 Protrusion
21 Flat surface
22 Inclined surface
23 Steep slope
40 Fastening function portion
24 Ring
30 Nut main body
33 Bearing surface
31 Through hole
32 Internal thread
34 Annular leg portion
35 Outer peripheral surface
36 Inner peripheral surface
37 Recess
51 Ring-shaped protrusion
52 Radial protrusion
53 First inclined surface
54 Second inclined surface
55 Flat surface
56 Inclined surface on the outer peripheral side
60 Nut main body
61 Bearing surface
62 Annular leg portion
63 Outer peripheral surface
64 Inner peripheral surface

1. A fastening member caulked and fixed to a mating member, the fastening member characterized by comprising:
a bearing surface that is press-fitted into the mating member or comes into contact with the mating member at time of caulking;
a fastening function portion formed in a central portion of the bearing surface; and
a plurality of protrusions formed to protrude from the bearing surface at positions surrounding the fastening function portion, characterized in that
the protrusions include an inclined surface inclined so as to approach the bearing surface from an outer peripheral side toward an inner peripheral side.

2. The fastening member according to claim 1, characterized by further comprising a recess into which a material of the mating member flows at the time of caulking between the fastening function portion and the bearing surface.

3. The fastening member according to claim 1, characterized in that the plurality of protrusions include a ring-shaped protrusion and a radial protrusion formed at a position between the fastening function portion and the ring-shaped protrusion.

4. The fastening member according to claim 2, characterized in that the fastening function portion is a shaft portion including an external thread.

5. The fastening member according to claim 2, characterized in that the fastening function portion is a through hole having an internal thread or having no internal thread.

6. The fastening member according to claim 4, characterized in that a recess into which the material of the mating member flows at the time of caulking is formed between the bearing surface and an incomplete thread portion of an end portion of the external thread.

7. The fastening member according to claim 4, characterized in that a recess into which the material of the mating member flows at the time of caulking is formed between the bearing surface and a ring formed at an end portion of the shaft portion including the external thread.

8. The fastening member according to claim 5, wherein a recess into which the material of the mating member flows at the time of caulking is formed between the bearing surface and an annular leg portion formed around the through hole.
